(19) United States
(12) Patent Application Publication
(10) Pub. No.: US 2010/0108779 A1
(43) Pub. Date: May 6, 2010

(54) Spraying Device With Liquid Adjustment Mechanism

(76) Inventor: Ehsan Filsouf, Richmond Hill (CA)

Correspondence Address: CANTOR COLBURN, LLP, 20 Church Street, 22nd Floor, Hartford, CT, 06103, US

(21) Appl. No.: 12/431,806

(22) Filed: Apr. 29, 2009

Related U.S. Application Data
(63) Continuation-in-part of application No. PCT/IB2007/003250, filed on Oct. 29, 2007.

(30) Foreign Application Priority Data
Oct. 30, 2006 (CN) 200620149198.0

(51) Int. Cl. B05B 7/00; B65D 83/14

(52) U.S. Cl. 239/61; 239/304; 222/635

(57) ABSTRACT

The present invention relates to a fragrance or paint sprayer. The sprayer, comprises a spraying mechanism, two liquid containers, a liquid adjustment mechanism; the spraying mechanism having a knob for activating a pump or a release valve for dispensing a liquid coming from an inlet to an outlet; two liquid feeding tubes, one end of each of the two liquid feeding tubes being in liquid communication with each of the two liquid containers respectively, and the other end of each of the two liquid feeding tubes being jointed and connected to the inlet of the spraying mechanism; the liquid adjustment mechanism comprising two sets of adjoining sloped surfaces and sets of rollers in surface contact with respective flexible portions of each of two liquid feeding tubes and, when the rollers are moving from right to left, changing flow passage areas inside the flexible portions in such a way that the amount of liquid supplied from each of the two liquid containers through each of the two liquid feeding tubes is adjusted. When flow of liquid from one feeding tube is increased by the adjustment mechanism, the flow from the other feeding tube decreases in a way that the total amount of the liquid supplied by the two feeding tubes is substantially constant. In practice, it is possible to mix two liquids, such as two different perfumes with different fragrances to create a new fragrance, or two different color paints to create a new paint color.

### CROSS-REFERENCE TO RELATED APPLICATIONS

This application is a continuation-in-part of PCT Patent Application PCT/IB2007/003250 filed Oct. 29, 2007, the contents of which are incorporated by reference herein in their entirety, which claims the benefit of Chinese Patent Application 200620149198.0 filed Oct. 30, 2006, the contents of which are incorporated by reference herein in their entirety.

### BACKGROUND OF THE INVENTION

1. Field of the Invention

The present invention relates to spraying devices, a perfume or Eau de Cologne Sprayer and/or a Paint Sprayer and/or a portable multipurpose spraying mechanism. More particularly, the invention comprises a spraying device having two liquid fragrance containers, or liquid paint containers; wherein the contents of both liquid containers are up-taken and mixed by degree by means of the device pump or uptake assembly, and the user can regulate, by means of the liquid adjustment mechanism, the amount of each liquid up-taken. The outcome is a custom mixture from two liquid containers. The present invention enables users to have a different fragrance, and/or a different color, or mixture variation of other kinds of liquids, on demand.

2. Description of the Prior Art

At present, there are some sprayers with liquid adjustment mechanisms; such liquid adjustment mechanisms may adjust the amount of liquid by placing valves or other adjustment mechanisms within the passages of liquid. For example, in U.S. Pat. No. 5,634,571, the selector member is in liquid communication with the first and second passages in the manifold member, it is selectably rotatable to different positions, in which opening of the selector member is selectively in liquid communication with portions of passages with portions of outlets of passages blocked. In U.S. Pat. No. 5,568,883, the selector member is in liquid communication with the manifold member, and it is selectably rotatable to different positions, in which opening of the selector member is selectively in liquid communication with portions of passages with portions of outlets of passages blocked. In U.S. Pat. No. 5,009,342, the valve assembly is connected with compartments and the spray pump, and adjustment of the amount of different liquids is realized by parts of this valve assembly. In U.S. Pat. No. 5,385,270, the selector member is in liquid communication with the manifold member, and it is selectably rotatable to different positions, in which opening of the selector member is selectively in liquid communication with portions of passages with portions of outlets of passages blocked.

However, the sprayers mentioned above have complicated structures and the liquid to be adjusted must go through the adjustment devices, which therefore may result in possible contamination therefrom. The present invention adjusts the up-taken contents of its containers without liquid contact ever being achieved by the liquid adjustment device. This is achieved by the unique adjustment mechanism of the present invention which uses rollers to selectively compress and decompress flexible portions of the feeding tubes.

None of the above inventions and patents, taken either singly or in combination, is seen to describe the instant invention as claimed.

### SUMMARY OF THE INVENTION

The present invention provides a liquid sprayer which has a liquid pump, in the case of the fragrance sprayer embodiment, or a pressurized spray mechanism in the case of the paint sprayer and/or pressurized fragrance embodiment. The device has two liquid containers which contain different fragrances or different color liquid paints. The adjustment mechanism mixes the liquids from the two provided liquid containers in proportions determined by the user by sliding the adjustment knob. The liquid fragrance containers and/or liquid paint containers are easily replaceable by just unscrewing one to remove it and screwing another one in its place, allowing for a variety of different liquids to be mixed in desired proportions. By using an instruction guide, the user can create a variety of fragrances and/or colors.

The liquid adjustment mechanism comprises two adjustment members, such as rollers, and two sloped surfaces located under two flexible tubes respectively. Each sloped surface is configured, respectively, so that the height of the surface changes along the longitudinal direction of the corresponding flexible tube and in the pathway of the motion of corresponding roller, so that the flexible tubes are longitudinally placed against the extending sloped surfaces respectively. Two rollers are placed above the flexible tubes respectively and corresponding roller may move longitudinally along the upper outside surface of the flexible tube on the sloped surface. The sloped surfaces slope in the direction parallel to the longitudinal direction of the flexible tubes. The two sloped surfaces intersect with each other at the center point of adjustment mechanism assembly housing. This intersection is the peak height of the sloped surfaces where their highest ends are, with the lowest ends being at the opposite end of each sloped surface, respectively.

Since the adjustment members move along a horizontal path but the flexible tubes are on a sloped surface, the pressure exerted by an adjustment member on the corresponding flexible tube is at a minimum when it is at the lowest end of the slope, accordingly, the flow passage inside the flexible tube is at its widest. The pressure exerted by the adjustment member gradually increases as the adjustment member moves towards the tube's highest end, causing the flow passage inside the flexible tube to become narrower correspondingly. When the adjustment member arrives at the tube's highest end, the pressure is at a maximum and, accordingly, the flow passage inside the flexible tube is the narrowest, or entirely blocked.

As a result, when an adjustment members is at a tube's lowest end, the amount of liquid that flows through the flexible tube is at a maximum, and it gradually decreases as the adjustment member moves towards the tube's highest end, at which point the flow of liquid is either at a minimum or blocked entirely.

The adjustment members are fixed to a frame and move simultaneously in the same direction, but since the highest end of the sloped surfaces are facing each other with the lowest ends being at the other two opposite ends, during the movement of the frame when the pressure of one adjustment member increases on a corresponding tube, the pressure exerted by the other adjustment member on the other tube decreases correspondingly, and vice versa.

Consequently, moving the frame results in changing the amount of flow in the tubes in opposite ratios with respect to each other. Therefore, by sliding an adjustment knob which is fixed to the frame, the user can increase the amount of liquid up taken from one container while simultaneously decreasing the amount of liquid up taken from the other container, thereby controlling the mixture ratio of the two liquids before dispensing.

In another embodiment of the present invention, there is no adjustment knob, and two detachable containers filled with pressurized content are screwed into the sprayer; the proportion of the content taken from each container is equal. Therefore, by pressing the pump—or alternatively a trigger—the output would be an even mixture of the content of the containers.

Accordingly, it's the principle object of the present invention to provide a fragrance sprayer and/or paint sprayer that has two liquid containers which can be replaced.

It is another object of the invention to provide liquid containers which are filled with various fragrances, liquids, creams, gels, lotions and alternately pressurized content.

Another object of the invention is to provide replaceable containers which can be screwed onto and off of the device.

It is another object of the invention to provide a sprayer that makes it possible to mix liquid from said liquid containers in any proportion and create a new fragrance or paint color variation or other pressurized content.

It is further an object of the invention to provide a liquid sprayer that can adjust the proportion of outgoing liquid contents of the two containers such as fragrance, or pressurized content, such as paint, by sliding the knob to the left or to the right. This feature allows the user to create a wide variety of scents and, in the alternative embodiment, a wide spectrum of colors or other mixtures of pressurized contents.

Still another object of the invention is to provide a fragrance sprayer which can spray Eau de Cologne, Eau de Toilette or perfume with a desirable mixture of alcohol and perfume concentrate oil.

Another object of this invention is to provide a sprayer for sunscreen application which allows the user to adjust the amount of UV filter by sliding a knob.

An additional object of the invention is to provide a sprayer in which the lids or covers of the liquid containers can be made in different colors, indicating different scents of the fragrance or different colors of paint within the containers and/or which includes a booklet of color codes or fragrance mixes to help the user create desired mixture variations.

It is again an object of the invention to provide a sprayer having a spray mechanism liquid route that is air tight with no possible evaporation, contamination, or leakage.

It's another object of the invention to provide a fragrance sprayer that, despite its adjustment mechanism and replaceable containers, is similar in shape and appearance to conventional units available in the market.

It is still another object of the invention to provide a fragrance sprayer and/or paint sprayer with a lower detachable and re-attachable casing for replacement of the liquid containers.

It's another object of the invention to provide a fragrance sprayer and/or a paint sprayer which has a reasonable price.

It's another object of the invention to provide a fragrance sprayer with a liquid pump which is quite similar to conventional types in the market, and which is economical from a manufacturing point of view.

Another object of the invention is to provide a sprayer which is easy to operate when mixing different proportions of liquids; a benefit derived from the design of the adjustment knob mechanism.

It is further object of the present invention to provide a paint sprayer giving the possibility to create several new colors by sliding the liquid adjustment knob to the right or to the left.

Another object of the invention is to provide a paint sprayer that uses conventional paint spray cans which are available in the market.

Another object of the invention is to provide a paint sprayer that mixes the paint from two liquid containers, creating variant color shades in a wide spectrum of colors. For example by mixing yellow and blue in different variations many different shades of green, blue and yellow can be created.

Another object of the invention is to provide a paint sprayer that, by turning the unit upside down, a user may simply clean the nozzle by pressing a lever and releasing the air contained in the system.

These and other objects of the present invention will become readily apparent upon review of the following specifications and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective front view of the fragrance sprayer 1 of the present invention;

FIG. 2 is a perspective front view of the fragrance sprayer of the present invention with upper cover detached;

FIG. 3 is the front view of the fragrance sprayer of the present invention;

FIG. 4 is a cross sectional view of the fragrance sprayer of the present invention from line 4-4 of FIG. 1;

FIG. 5 is the cross sectional view of the fragrance sprayer of present inventions from line 5-5 in FIG. 3;

FIG. 6 is a detailed cross sectional view of the liquid adjustment mechanism of the fragrance sprayer of the present invention as isolated at 6 of FIG. 4.

FIG. 7 is a detailed cross sectional view of the liquid adjustment mechanism of the fragrance sprayer of present invention at line 7-7 of FIG. 2;

FIG. 8 is the exploded perspective view of the fragrance sprayer of the present invention;

FIG. 9 is a perspective front view of the paint sprayer 2 of the present invention;

FIG. 10 is a perspective back view of the of the paint sprayer embodiment of the present invention;

FIG. 11 is a cross sectional view of the paint sprayer embodiment of the present invention at line 11-11 of FIG. 10;

FIG. 12 is a detailed cross sectional view of the paint sprayer's liquid adjustment mechanism of the present invention as isolated at 12 of FIG. 11.

FIG. 13 is a cross sectional view of the paint sprayer's liquid adjustment mechanism of the present invention at line 13-13 of FIG. 11;

FIG. 14 is a cross sectional view of, line connecting cylindrical coupler of paint sprayer at line 14-14 of FIG. 12;

FIG. 15 is an exploded perspective view of the paint sprayer embodiment of the present invention;

FIG. 16 is a perspective front view of the sprayer 3 which is another embodiment of the present invention with pressurized containers and no adjustment knob, allowing for an even mixture of the content of the containers.

FIG. 17 is an exploded perspective view of the sprayer 3 of the present invention.

### DETAILED DESCRIPTION OF THE PREFERRED EMBODIMENTS

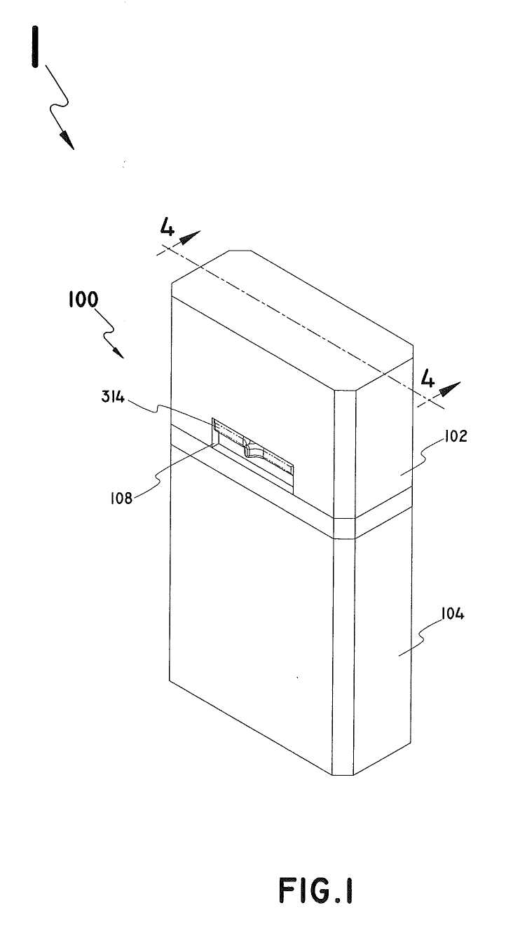

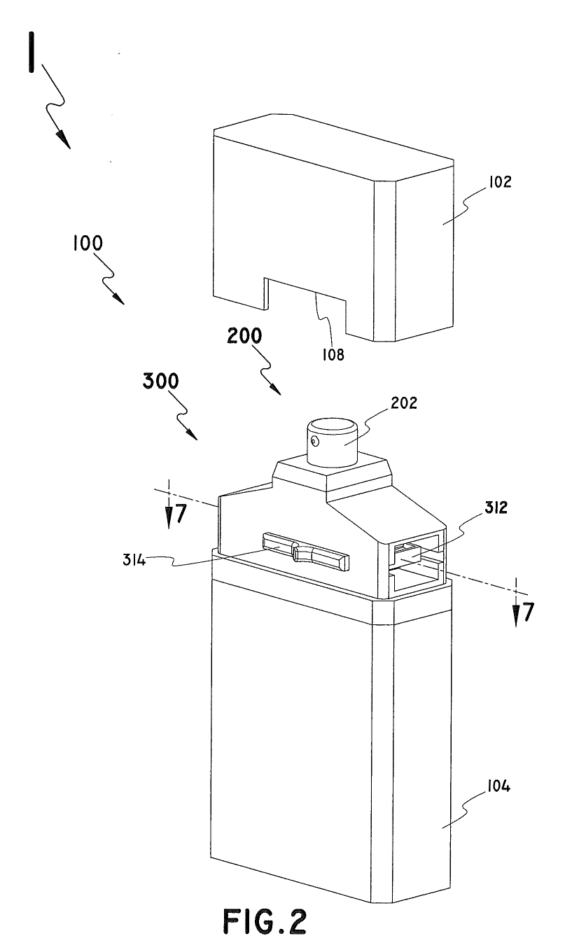

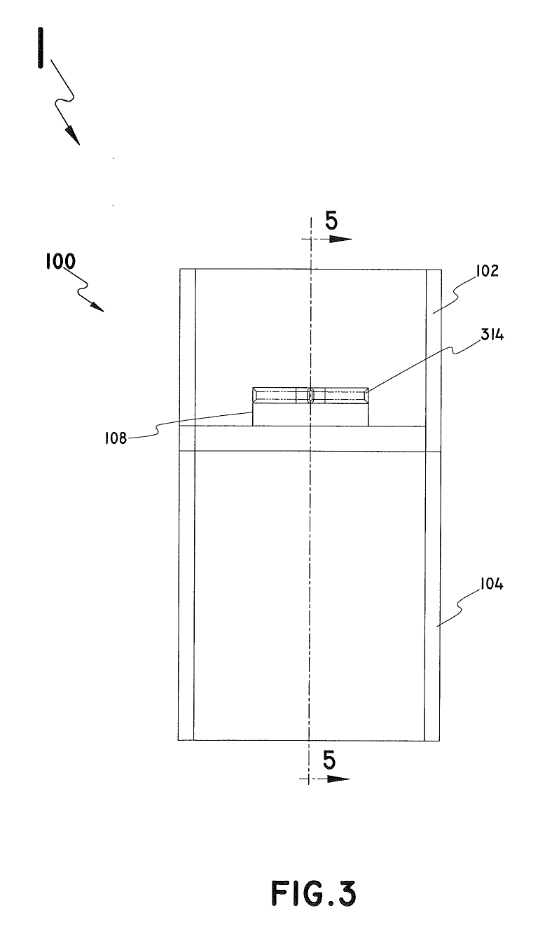

The fragrance sprayer 1 generally presented at FIGS. 1, 2, 3 and 4 includes the casing assembly 100 and the liquid adjustment mechanism assembly 300, spraying mechanism assembly 200 and liquid container assembly 400.

The casing assembly 100 comprises detachable liquid container assembly housing 104 and liquid assembly adjustment assembly detachable cap 102 and recess 108.

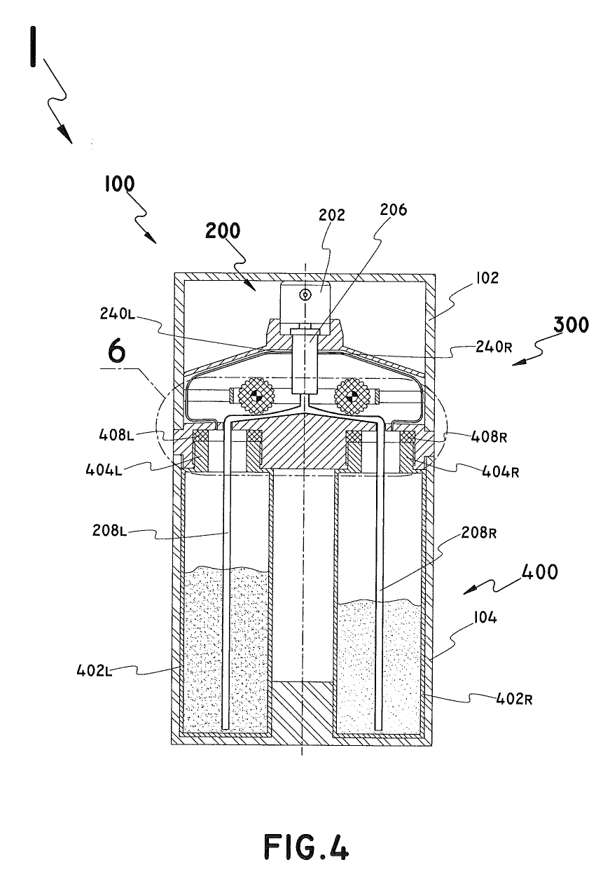

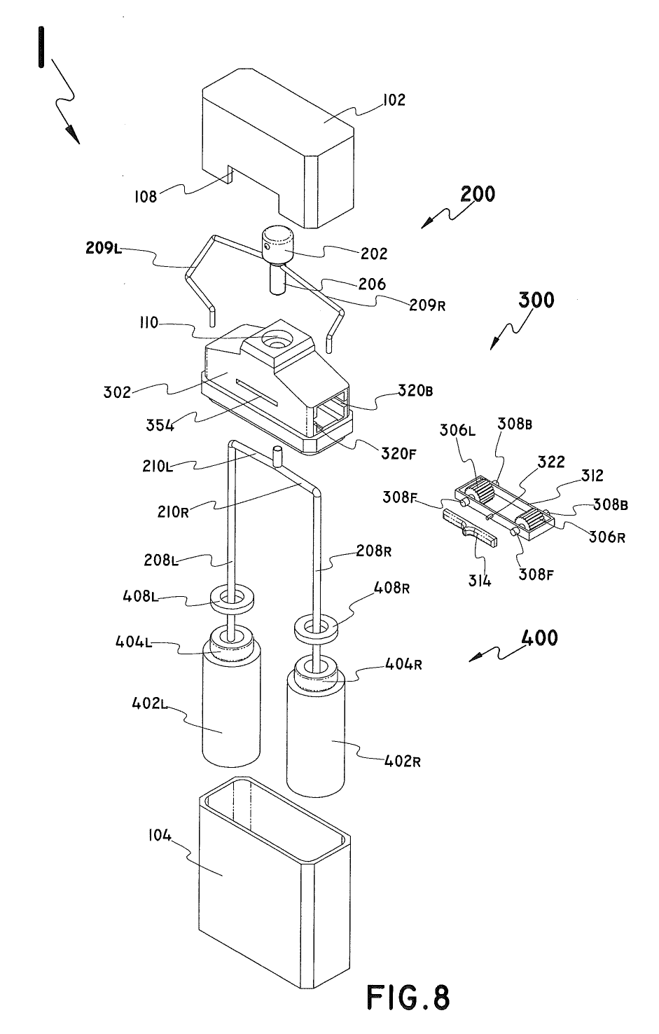

Referring to FIGS. 4, 6 and 8, the spray mechanism assembly 200 is comprised of spraying nozzle 202, liquid pump 206, flexible tubes 210R and 210L and suction tubes 208R and 208L. The air balancing tubes 209R and 209L, which are known in the art, are connected from one end to top of the liquid containers 402R and 402L and from the other end to the outside air access apertures 240R and 240L located at both sides of the pump respectively.

Furthermore, casing assembly 100 comprises aperture 110 at the top of liquid adjustment mechanism assembly housing in which liquid pump 206 is fixedly located. Referring to FIGS. 4, 6 and 8 the liquid container assembly 400 is comprised of two liquid containers 402R and 402L. The threaded liquid container necks 404R and 404L allow the liquid containers to be attached by screw motion to the sprayer. The inlets 352R and 352L are provided on lower outer surface of the liquid adjustment mechanism assembly housing 302 and are threaded from inside. Gaskets 408R and 408L make air tight the connections between the necks 404R and 404L and the top surfaces of the inlets 352R and 352L, respectively.

The liquid containers 402R and 402L can be attached or detached from the liquid container assembly housing 104 by screwing or unscrewing necks 404R and 404L into or from the inlets 352R and 352L, respectively.

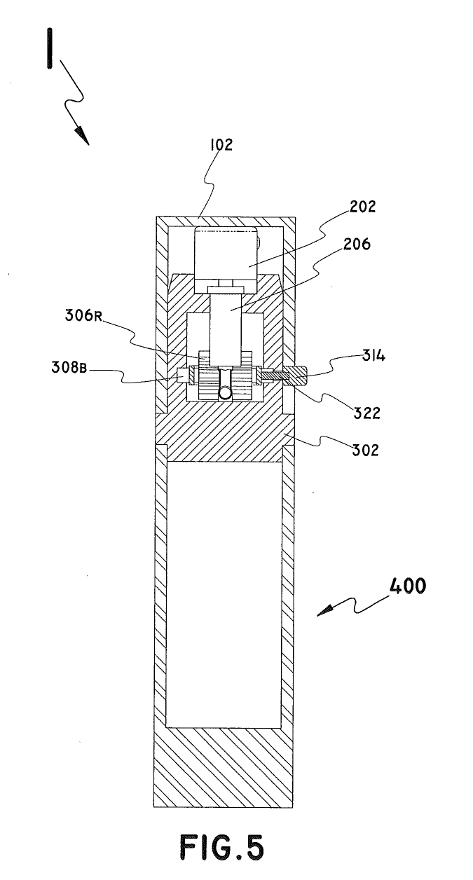

Now referring to FIGS. 1 through 8, the liquid adjustment mechanism assembly 300 comprises a liquid adjustment mechanism housing 302. 302 is substantially hollow with a shoulder on its upper section. The inside lower part of the housing 302 comprises two sloped surfaces 350R and 350L which intersect with each other at the center point of housing 302. This intersection is the peak height of each of the sloped surfaces, and the lowest height is at the two opposite ends of the sloped surfaces, respectively. Two parallel horizontal grooves 320F and 320B are provided on the two inner opposite surfaces of the liquid adjustment mechanism assembly housing 302. A horizontal slot 354 is provided on the front surface of said housing 302 allowing horizontal movement of the adjustment knob pin 322.

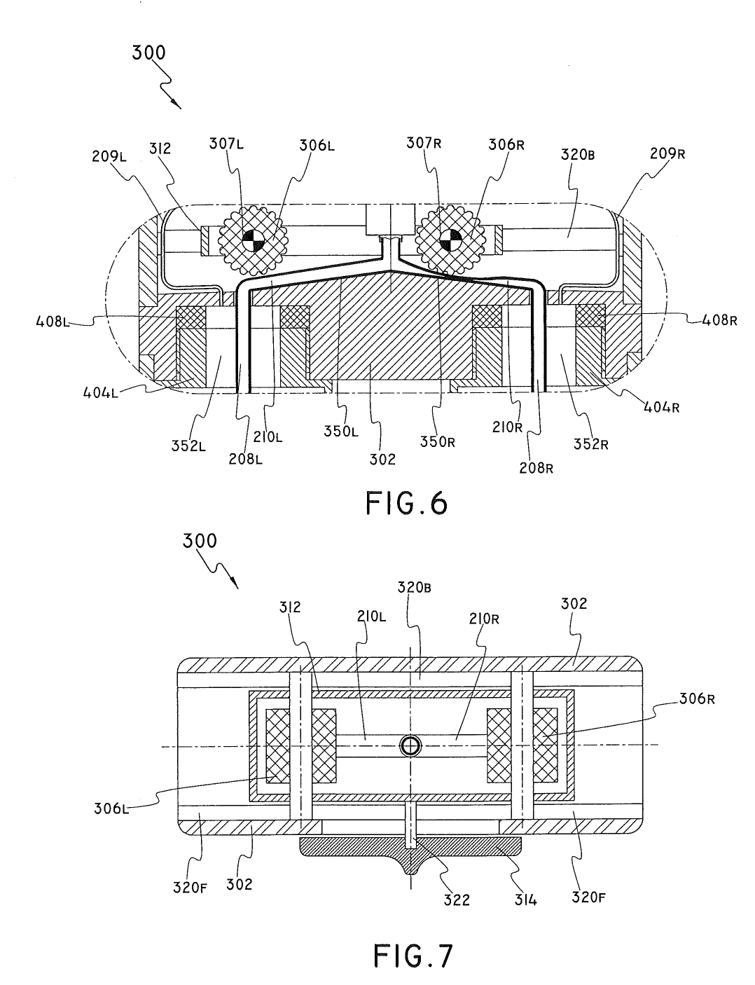

Now referring to FIGS. 6 through 8, the liquid adjustment mechanism assembly 300 further comprises a rectangular frame 312, two axle pins 307R and 307L which are fixedly attached to the frame 312 near the two short side ends of said frame. The axle pins 307R and 307L extend from the two long sides of said frame 312, with extension sets 308F at the front, and 308B at the back, being positioned inside grooves 320F and 320B, respectively, allowing frame 312 to travel horizontally along respective axes of said grooves. There are two rollers 306R and 306L which rotatably encircle the two axle pins 307R and 307L. The frame 312 and rollers 306R and 306L can freely move horizontally along the grooves 320F and 320B. The two flexible tubes 210R and 210L are spanned from right and left on the sloped surfaces 350R and 350L and are connected on their respective lower ends to two suction tubes 208R and 208L, and on their respective higher ends to the spray pump 206.

Further, pin 322 is fixedly connected to the center of the front long side of the frame 312 at one end and to the center of the liquid adjustment knob 314 at the other end. When the liquid adjustment knob 314 travels from its extreme position on the left to the right, the roller 306L gradually compresses and narrows the flow passage inside flexible tube 210L, while, simultaneously, roller 306R relaxes and widens the flow passage inside 210R, with reverse motion of the adjustment knob having an opposite effect, resulting in changing the amount of flow of the liquids within the flexible tubes, which determines the mix proportion of the liquids up-taken from the two liquid containers 402R and 402L.

In operation, the user holds the fragrance sprayer 1 at a reasonable distance from the human skin. The user can adjust the proportion of uptake from each of the liquid fragrance containers by sliding the adjustment knob 314 to the left or to the right to get the desired scent.

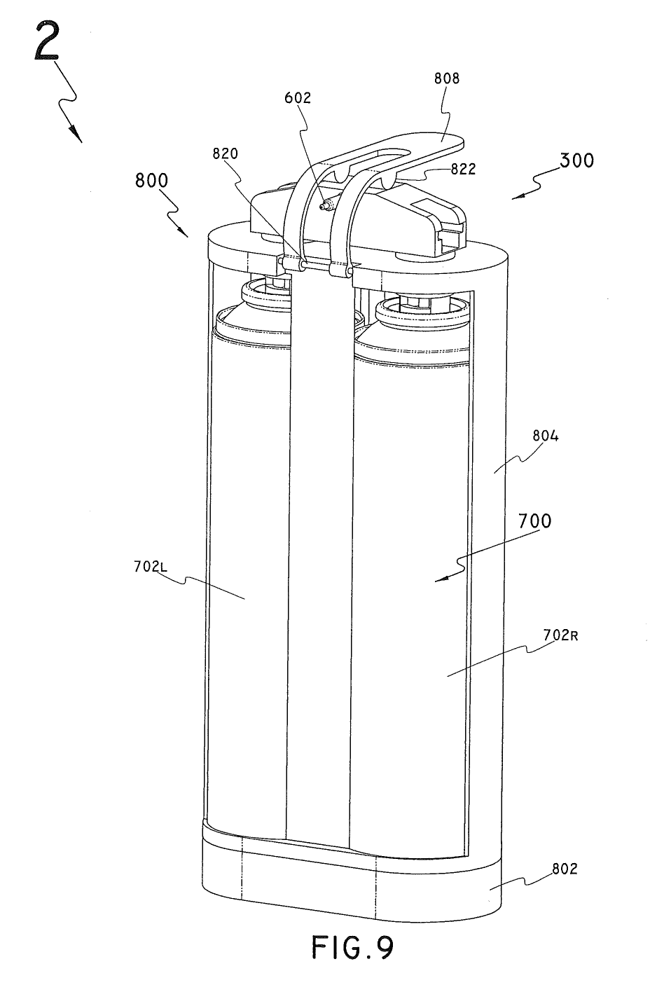

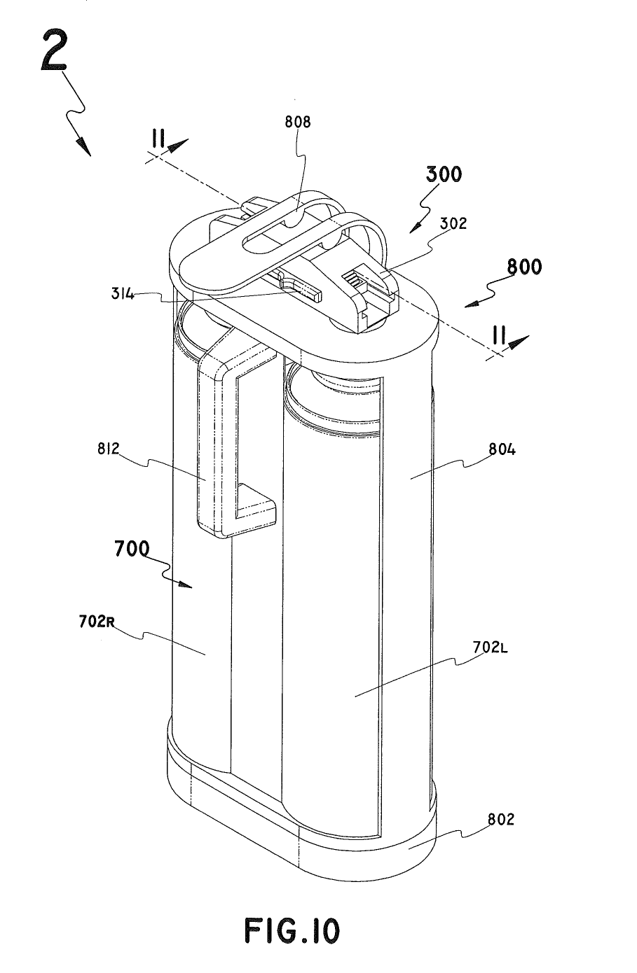

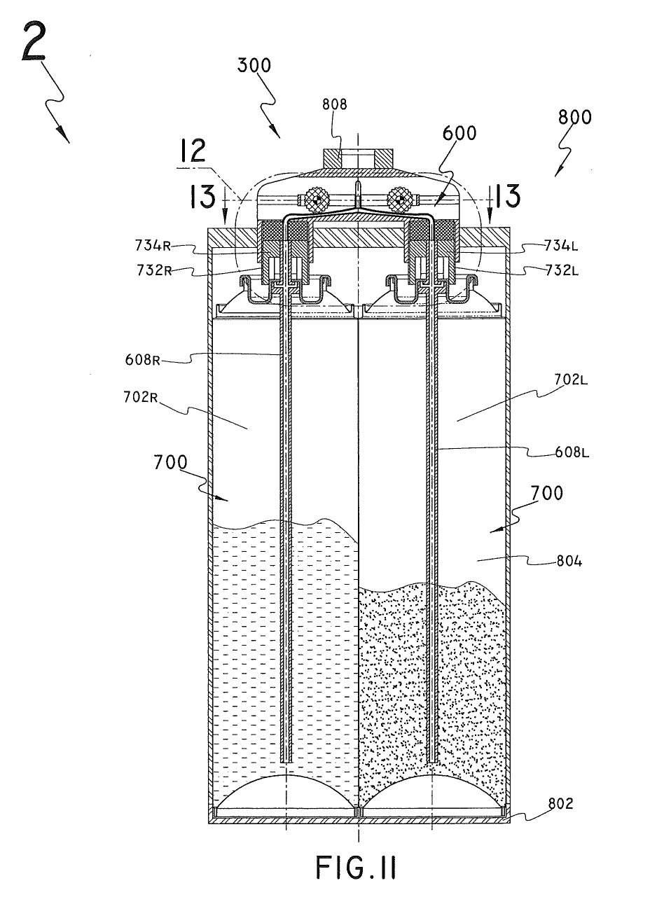

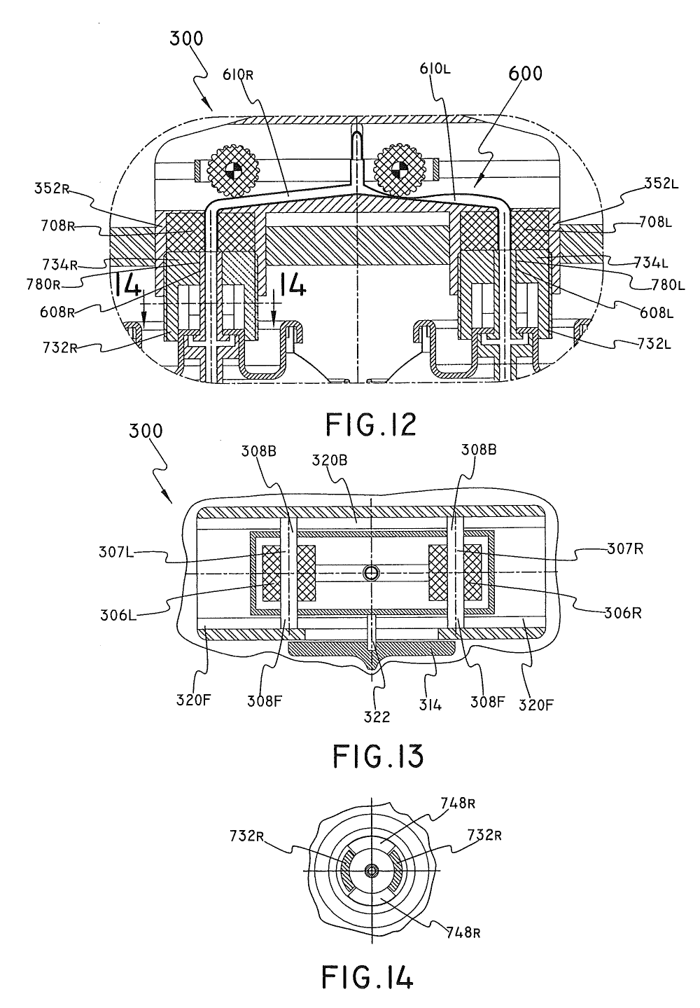

In an alternate embodiment, a paint sprayer 2 generally presented at FIGS. 9 through 11, includes a casing assembly 800, the liquid adjustment mechanism assembly 300, the spray mechanism assembly 600 and liquid paint container assembly 700.

Referring to FIGS. 9 through 11 and 15, casing assembly contains partial housing 804 and lower detachable base 802 and spray lever 808 and handle 812, the lower detachable base 802 allows for replacing the liquid paint containers. The spray lever 808 is moveably affixed to the top of partial housing 804 by hinge pin 820. Spray lever 808 has two protrusions 822 on its lower surface which are in surface contact with the top surface of liquid adjustment mechanism assembly housing 360. The spray lever 808 is designed to activate the sprayer with minimal applied pressure, facilitating ease of operation.

The liquid paint adjustment mechanism assembly 300 is functionally the same as in the fragrance sprayer 1 as formerly described.

The liquid paint adjustment mechanism assembly moves down when pressure is applied on spray lever 808 and moves back to position when spray lever is released.

Referring to FIGS. 9, 11, 12 and 15. The spray mechanism assembly 600, consists of a spray nozzle 602, paint mix inlet 616, flexible tubes 610R and 610L and the uptake tubes 608R and 608L. The liquid paint containers are pressurized.

Referring to FIGS. 9 through 12, 14 and 15. The liquid container assembly comprises two liquid paint containers 702R and 702L. The liquid containers are similar to the common paint spray cans found in the market. The liquid paint containers 702R and 702L are available in different colors and are easily replaceable.

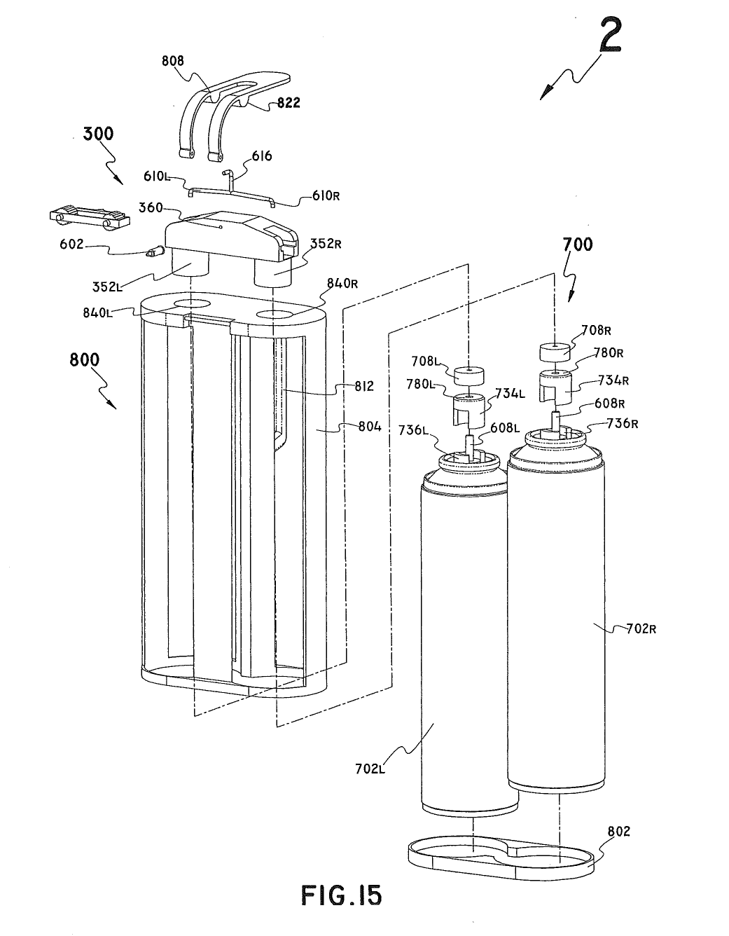

The liquid paint container assembly further comprises connecting cylindrical coupler sets 734R and 734L having aperture sets 780R and 780L in their centers, in which the upper end of the uptake tubes 608R and 608L are respectively fixedly attached, the connection being watertight. The circular outer surfaces of said connecting cylindrical coupler sets are threaded on the outside circumferences. There are also two identical circular receiving parts 736R and 736L configured to receive the connecting cylindrical couplers. Sets 734R and 734L, which have protrusions 732R and 732L, respectively, and sets 736R and 736L, which have protrusions 748R and 748L, respectively, are interlocking and the latter are fixedly attached at top end of the liquid paint containers 702R and 702L and moveably encircle the uptake tubes 608R and 608L. Still the sets of 734R and 734L and sets of 736R and 736L can have vertical movement in relation to each other, respectively, along the longitudinal axis of uptake tubes 608R and 608L, while rotation of the sets of 734R and 734L and 736R and 736L in relation to each other around the longitudinal axis is restricted. As shown in FIG. 14, the protrusions 732R and 748R interlock. Similarly, though not shown, the protrusions 732L and 748L also interlock.

Further, the sets of inlets 352R and 352L have female threading on their interior surfaces receiving corresponding threading located on the outsides of connecting cylindrical couplers 734R and 734L in a manner defined by the restricted circular motion described, allowing the sets of inlets and connecting cylindrical couplers to become screwed together and airtight by means of gasket sets 708R and 708L respectively. The outside surface of the two inlet sets 352R and 352L are moveably seated in the set of apertures 840R and 840L and vertically move up and down when the lever 808 is pressed down and released accordingly.

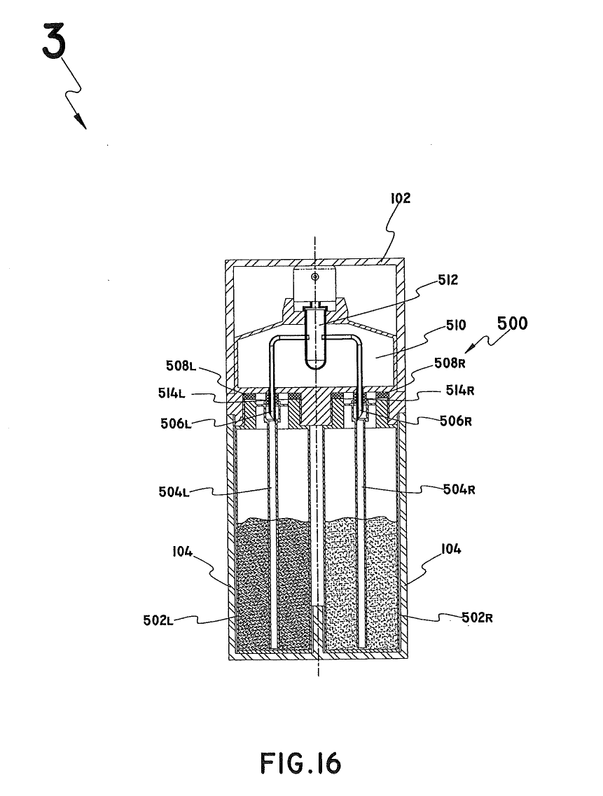

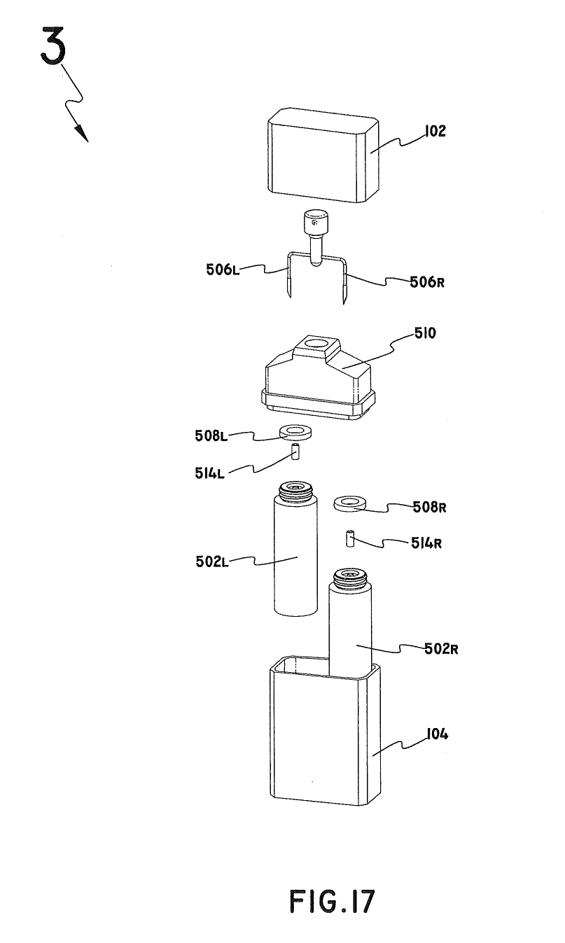

In operation, to activate the paint sprayer 2, lever 808 is manually pressed down. The adjustment mechanism assembly and the set of inlets 352R and 352L will move down causing the connecting cylindrical coupler sets and consequently the attached uptake tube sets 608R and 608L to move down which opens the common paint valve inside the liquid paint container. The inside of the liquid paint containers are pressurized. The user can adjust the proportion of uptake from each of the liquid paint containers by sliding the adjustment knob 314 to the left or to the right to get the desired color result. In another alternate embodiment, sprayer 3 generally presented at FIGS. 16 and 17, utilizes adjustment mechanism assembly 500 for pressurized content. In Sprayer 3 which is depicted in FIGS. 16 and 17 there is no adjustment knob and the mixture ratio of the contents of the containers is fixed. However, it is possible to make Sprayer 3 with an adjustment knob similar to the previous embodiments, allowing for adjustment of the mixture ratio.

Referring to FIGS. 16 and 17, assembly housing 510 houses connection tubes 506R and 506L which are connected to liquid pump 512 from one end and penetrate the top of the containers 502R and 502L from the other end respectively.

Further, as known in the art, while inserting containers 502R and 502L inside assembly housing 510 by screw motion, connection tubes 506R and 506L's sharp tips puncture the sealed inlet of containers 502R and 502L, respectively. The content of the containers is pumped up through uptake tubes 504R and 504L into connection tubes 506R and 506L by liquid pump 512. Cylindrical gaskets 514R and 514L prevent the content from escaping when the container inlets are punctured by sharp tips of connection tubes 506 R and 506L during screwing of the containers into place; and after the containers are tightly in place, sealing ring gaskets 508R and 508L ensure that the connection is air tight.

The replaceable liquid containers in the above embodiments can be distributed with colored lids or labels indicating different scents in the case of the fragrance sprayer embodiment, or different colors of paint in the case of the paint sprayer embodiment. An instruction booklet can also be provided to help the user to select the required scent or color, based on the lids' color or label, as well as the proportion of mix of the liquids up-taken from each of the two containers.

It would, likewise, be evident to one of ordinary skill in the art that the sprayer could be manufactured of a variety of different materials, such as metals, glass or various polymerics or plastics.

The above embodiments are not limiting this invention. The person skilled in the art should understand that many modifications, changes or equivalents may be obtained from the present invention without departing from the spirit and scope of the present invention, which are all included in the scope of the claims attached herewith.

What is claimed is:

1. A sprayer comprising:
a casing for giving said sprayer form and supporting the following working elements of said sprayer:
two containers for holding a first liquid and a second liquid, respectively, said containers being attachable and detachable, allowing for their replacement,
a spraying system, said spraying system comprising a pump for dispensing a mixture of said first liquid and said second liquid,
flow adjustment structure, said flow adjustment structure comprising:
two feeding tubes, each of said feeding tubes having a first end and a second end, said first end of each of said feeding tubes being in airtight fluid communication with a respective one of said containers, said second end of each of said feeding tubes having a flexible portion, each said flexible portion having a flow passage with a cross-sectional area and having a flow passage with a cross-sectional area and being connected to said pump for discharging a mixture of said first and second liquids uptaken from said containers,
two flow adjustment members which function to selectively control the proportion of said first liquid and said second liquid in the mixture being dispensed such that there is an inversely proportional relationship between the amount of said first liquid and the amount of said second liquid in the mixture.

2. A sprayer, as defined in claims 1, wherein said flow adjustment structure further comprises two sloped surfaces, each of said sloped surfaces having a highest end and a lowest end, and said sloped surfaces are positioned under respective ones of said flexible portions of said feeding tubes.

3. A sprayer, as defined in claim 1, wherein, for each of said flexible portions, said cross-sectional area of said flow passage can be changed by external pressure in such a way that the amount of liquid uptaken from each of said containers through each of said feeding tubes can be adjusted, respectively.

4. A sprayer, as defined in claims 1, wherein each of said flow adjustment members is in juxtaposition with an outer surface of each of said flexible portions, respectively, in such a way that the motion of a said flow adjustment member over the outer surface of a said flexible portion will create a corresponding change in said flow passage cross-sectional area inside said flexible portion.

5. A sprayer, as defined in claims 2, wherein, for each of said flow adjustment members:
when said flow adjustment member is moved to a position corresponding to said lowest end of said respective sloped surface, said corresponding flow passage area inside said corresponding flexible portion is at its widest and, therefore, the amount of flow through said corresponding flexible portion to said pump is at a maximum, and
during movement of said flow adjustment member toward said highest end of said respective sloped surface, said corresponding flow passage area inside said corresponding flexible portion narrows down correspondingly and, therefore, the amount of flow through said flexible portion to said pump decreases correspondingly, and
when said flow adjustment member is moved to a position corresponding to said highest end of said sloped surface, said flow passage area inside said corresponding flexible portion is the narrowest and, therefore, the amount of flow through said flexible portion to said pump is either stopped or is at a minimum.

6. A sprayer, as defined in claim 5, wherein said flow adjustment members are fixed to a frame and said frame is fixed to an adjustment knob, with movement of said adjustment knob being restricted between two end points, such that
moving said adjustment knob from one of said end points to the other one of said end points will result in one of said flow adjustment members moving from a position corresponding to said lowest end of its respective sloped surface to a position corresponding to said highest end of its respective sloped surface, while simultaneously moving the other said adjustment member from a position corresponding to said highest end of its respective sloped surface to a position corresponding to said lowest end of its respective sloped surface, thereby adjusting the flow proportion through each said flexible portion of said feeding tubes in inverse relationship with respect to each other.

7. A sprayer, as defined in claim 6, wherein each of said flow adjustment members has an axle, with opposite ends of said axles located, respectively, inside two grooves, and said grooves are on said frame, whereby moving said adjustment knob serves to simultaneously and inversely adjust the amount of each of said first liquid and said second liquid that make up the mixture to be sprayed.

8. A sprayer, as defined in claim 1, wherein said flow adjustment members are rollers.

9. A sprayer, as defined in claim 1, wherein said containers hold pressurized contents.

10. A sprayer, as defined in claim 1, wherein said containers are provided in different colors or with different labels indicating the contents of said containers.

11. A sprayer, as defined in claim 1, further comprising an instruction booklet which indicates the output result of using any combination of said containers in said sprayer.

12. A sprayer comprising:
a casing for giving said sprayer form and supporting the following working elements of said sprayer:
two pressurized containers for holding a first liquid and a second liquid, respectively, said containers being attachable and detachable, allowing for their replacement,
a spraying system, said spraying system comprising a pump for dispensing a mixture of said first liquid and said second liquid,
and a pair of connection tubes, said connection tubes each having a sharp end configured to penetrate into each of said containers, respectively.

13. A sprayer, as defined in claim 12, further comprising:
a pair of cylindrical gaskets positioned to prevent the content of said containers from escaping while said containers are being penetrated by said sharp ends, and
a pair of ring gaskets positioned to make the connection between said containers and said pump airtight.

14. A sprayer, as defined in claim 12, wherein a trigger spray mechanism is used to dispense the contents of said containers.

15. A sprayer, as defined in claim 12, wherein said containers hold paste, cream, gel or oil.

16. A sprayer comprising:
a casing for giving said sprayer form and supporting the following working elements of said sprayer:
two pressurized containers for holding a first liquid and a second liquid, respectively, said containers being attachable and detachable, allowing for their replacement,
a spraying system, said spraying system comprising:
a lever,
a pair of inlets,
a pair of couplers, said couplers configured for fixed attachment to a pair of receiving parts,
a pair of gaskets,
a pair of connection tubes, said connection tubes being removably attached to said containers.

17. A sprayer, as defined in claim 16, wherein said lever is in surface juxtaposition with said inlets, and said lever and said pair of inlets being capable of moving vertically in such a way that pressing on said lever will push down said inlets, allowing the content of said containers to flow through said connection tubes in such a way that a mixture of said first liquid and said second liquid can be dispensed.

18. A sprayer, as defined in claim 16, wherein said pair of gaskets, said pair of couplers and said pair of receiving parts are configured to engage in such a way as to make airtight the connection between said containers and said spraying system.

19. A sprayer, as defined in claim 16, wherein said pressurized contents are liquid paint.

20. A sprayer, as defined in claim 16, wherein a trigger spray mechanism is used to dispense the contents of said containers.

21. A sprayer, as defined in claim 16, wherein said containers hold paste, cream, gel or oil.
